(19) United States
(12) Patent Application Publication
(10) Pub. No.: US 2011/0125742 A1
(43) Pub. Date: May 26, 2011

(54) Auto-Publishing Photo Albums On A Home Server

(76) Inventors: Matthew D. Haines, Fort Collins, CO (US); Daniel Thero, Fort Collins, CO (US)

(21) Appl. No.: 13/054,810

(22) PCT Filed: Sep. 30, 2008
(86) PCT No.: PCT/US2008/078292

§ 371 Date: Jan. 19, 2011

(51) Int. Cl. G06F 17/30

(52) U.S. Cl. 707/736; 707/E17.116; 707/E17.009

(57) ABSTRACT

A system for selectively publishing multimedia files 212 and corresponding method therefor are described. The system comprises a processing device 200; a network interface 206; and a storage device 210. The storage device 210 comprises: a set of multimedia files 212 each having at least one attribute 220; a set of predetermined rules 218; and a set of executable instructions which, when executed by the processing device 200, cause the processing device 200 to receive one or more multimedia files 212 each having at least one attribute 220; automatically generate a collection of multimedia files 212 by applying the set of predetermined rules 218 to at least one attribute 220 of each of the received one or more multimedia files 212; and publish the generated collection of multimedia files 212 for access.

### BACKGROUND

Photo sharing applications such as Webshare that run on home servers are designed to organize and share photos with friends and family. However, these applications require that the users manually add photos to the albums, which can be a problem when many new photos are continually available to the server.

Prior solutions to ease photo uploads for photo album applications have centered on better interfaces for selecting and transferring photos, including multiple select and drag and drop.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level functional block diagram of a network layout in which an automatic publishing system according to an embodiment may be used to advantage;

FIG. 2 is a high-level functional block diagram of a computer system according to an embodiment;

FIG. 3 is a high-level functional block diagram of a controller-based system according to an embodiment;

FIG. 4 is a high-level functional process flow of a portion of an automatic publishing system according to an embodiment; and

FIG. 5 is a high-level functional process flow of a portion of generate collection functionality according to an embodiment.

### DETAILED DESCRIPTION

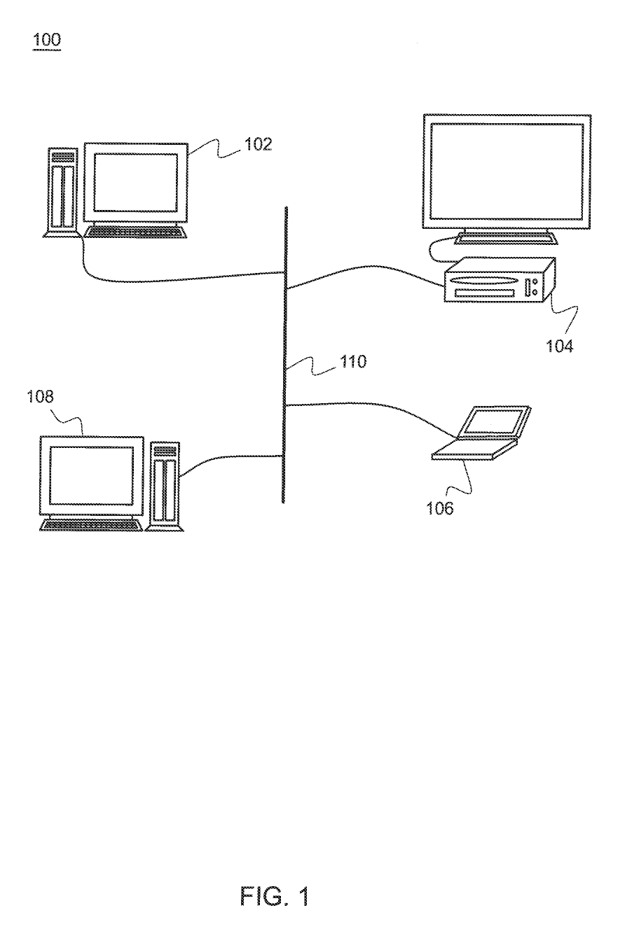

FIG. 1 depicts a high-level functional block diagram of a network layout 100 comprising a computer system 102, a controller-based system 104, a portable computer system 106, and another computer system 108 all communicatively coupled to each other via network 110. In at least some embodiments, network 110 may comprise a local area network (LAN) or a wide area network (WAN). In at least some embodiments, network 110 comprises one or more wired and/or wireless connections. In at least some embodiments, network 110 is a part of the packet-switched network commonly referred to as the Internet.

In at least some embodiments, one or more of computer system 102, controller-based system 104, portable computer system 106, and computer system 108 may be physically located adjacent one another in the same proximate area and/or building or structure. In at least some embodiments, the systems may be geographically disperse.

In at least some embodiments, computer system 102 comprises a media server functionality for distributing multimedia files to users of one or more of computer system 102, controller-based system 104, portable computer system 106, and computer system 108. In at least some embodiments, computer system 102 comprises a web server functionality for distributing the multimedia files to one or more requesting web browser client software executing on the systems. Multimedia files may comprise image files, audio files, video files, and/or music files.

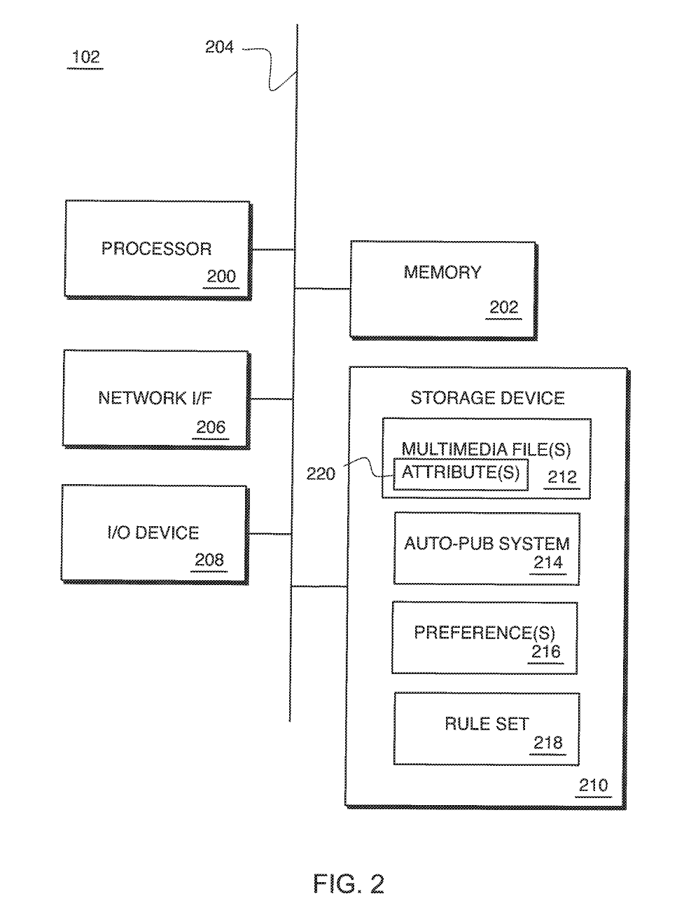

FIG. 2 depicts a high-level functional block diagram of computer system 102 usable in conjunction with one or more embodiments. Computer system 102 comprises a processor 200 (alternatively referred to as a processing device), a memory 202, a network interface (I/F) 206, a storage device 210, and an input/output device 208 communicatively coupled via a bus 204 or other interconnection communication mechanism.

Memory 202 (also referred to as a computer-readable medium) may comprise a random access memory (RAM) or other dynamic storage device, coupled to the bus 204 for storing data and/or instructions to be executed by processor 200. Memory 202 also may be used for storing temporary variables or other intermediate information during execution of instructions to be executed by processor 200. Memory 202 may also comprise a read only memory (ROM) or other static storage device coupled to the bus 204 for storing static information and instructions for the processor 200.

Network I/F 206 comprises a mechanism for connecting to network 110 (FIG. 1). In at least some embodiments, computer system 102 comprises more than a single network interface. In at least some embodiments, network I/F 206 may comprise a wired and/or wireless connection mechanism.

A storage device (alternatively referred to as storage 210), such as a magnetic disk, optical disk, or electromagnetic disk, may also be provided and coupled to the bus 204 for storing data such as one or more multimedia files 212, a file publishing system 214, preferences 216, and a rule set 218, and other data and/or instructions. Multimedia files 212 comprise one or more of image files, audio files, video files, and/or music files. Each multimedia file 212 comprises one or more attributes 220. In at least some embodiments, attributes 220 comprise one or more of an upload time, a file name, a file description, an originating computer, an originating device, a file size, or a combination thereof.

File publishing system 214 comprises a set of executable instructions which, when executed by processor 200, cause the processor to provide a multimedia file publishing system according to an embodiment. Preferences 216 comprise predetermined values corresponding to user and/or system specified settings influencing the execution of file publishing system 214. Rule set 218 comprises one or more predetermined rules specifying one or more criteria for selecting multimedia files 212 for inclusion in a collection to be published.

I/O device 208 may comprise an input device, an output device and/or a combined input/output device for enabling user interaction. An input device may comprise, for example, a keyboard, keypad, mouse, trackball, trackpad, and/or cursor direction keys for communicating information and commands to processor 200. An output device may comprise, for example, a display, a printer, a voice synthesizer, etc. for communicating information to a user. In at least some embodiments. I/O device 208 may comprise a serial and/or parallel connection mechanism for enabling the transfer of one or more of multimedia files 212.

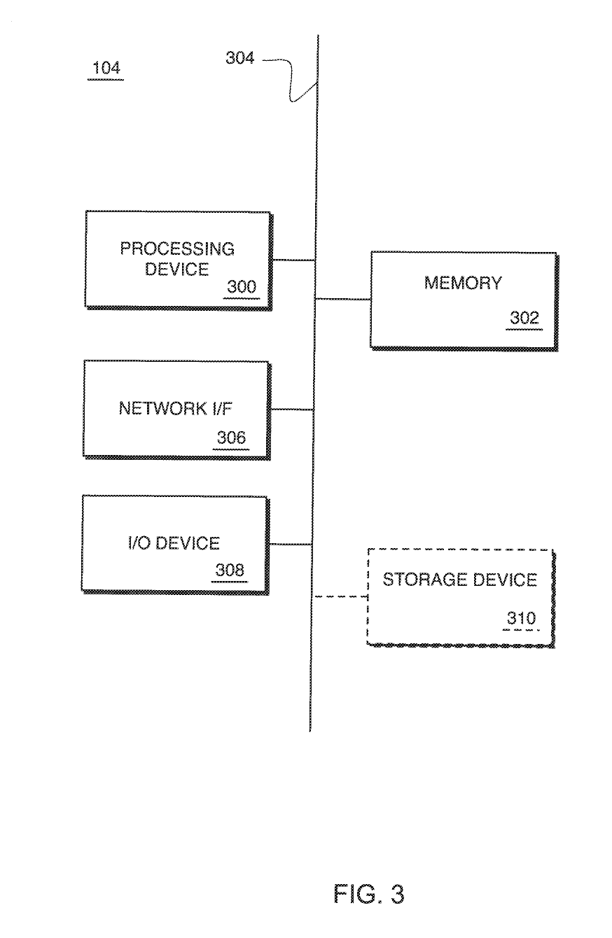

FIG. 3 depicts a high-level functional block diagram of an embodiment of controller-based system 104. Controller-based system 104 comprises a processing device 300, a memory 302, and a network interface (I/F) device 306 each communicatively coupled with a bus 304. Processing device 300 may be a processor, controller, and/or an application specific integrated circuit (ASIC) arranged to execute one or more instructions. Memory 302 (also referred to as a computer-readable medium) is coupled to bus 304 for storing data, e.g., multimedia files and/or web site files, and instructions to be executed by processing device 300. Memory 302 also may be used for storing temporary variables or other intermediate information during execution of instructions to be executed by processing device 300. In at least some embodiments, memory 302 comprises one or more magnetic, optical, or charge-based data storage media, e.g., a hard disk, for storing multimedia files. Memory 302 may also comprise a read only memory (ROM) or other static storage device coupled to bus 304 for storing static information and instructions for processing device 300.

Network I/F device 306 may comprise at least one of a wired connection or a wireless connection for enabling communication with other networked devices, e.g., via network 110.

I/O device 308 may comprise an input device, an output device and/or a combined input/output device for enabling user interaction. An input device may comprise, for example, a keyboard, keypad, mouse, trackball, trackpad, and/or cursor direction keys for communicating information and commands to processing device 300. An output device may comprise, for example, a display (as depicted in FIG. 1), a printer, a voice synthesizer, etc. for communicating information to a user. In at least some embodiments, I/O device 308 may comprise a serial and/or parallel connection mechanism for enabling the transfer of one or more of multimedia files 212.

In at least some embodiments, controller-based system 104 also optionally comprises a storage device 310 (dashed lines) for storing data, information, instructions for execution, and/or multimedia files 212 retrieved from computer system 102. In at least some embodiments, storage device 310 is similar to storage device 210 (FIG. 2).

Portable computer system 106 and computer system 108 comprise similar components as computer system 102. Portable computer system 106 and computer system 108 also comprise a browser client functionality in either or both of memory 202 and storage device 210 for connecting to and requesting multimedia file 212 from computer system 102.

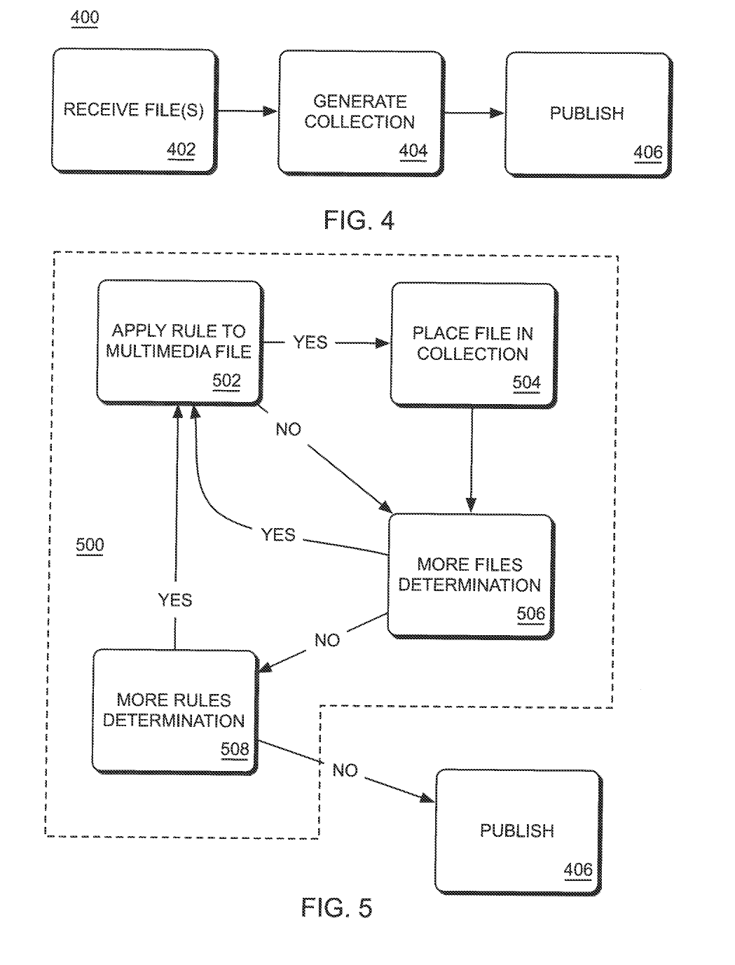

FIG. 4 depicts a high-level functional process flow diagram of at least a portion 400 of file publishing system 214 according to an embodiment. Portion 400 comprises a set of instructions for execution by processor 200 to cause the processor to perform the functionality specified by FIG. 4.

Process flow portion 400 begins at receive the functionality 402 wherein execution of a set of instructions by processor 200 causes the processor to receive one or more files, e.g. multimedia files 212 such as photo files, audio files, and/or video files. Responsive to receipt of the files, processor 200 stores the files in storage device 210.

In at least some embodiments, receive file functionality 402 also comprises receiving updated files. For example, updated files may comprise modified versions of previously received files, e.g., rotated, color corrected, or other adjusted files. In at least some embodiments, receive file functionality 402 comprises detecting a modification of a previously received file in storage device 210. In at least some embodiments, receive file functionality 402 comprises receiving multimedia file 212 from one portion of storage device 210 or from a multimedia device connected with I/O device 208 and/or network I/F 206, e.g., a camera, music device (player and/or instrument), or other device.

The flow of control proceeds to generate collection functionality 404 wherein the processor 200 generates a collection of multimedia files based on application of one or more predetermined rules of rule set 218. That is, based on comparing multimedia file 212 with a value of a rule, processor 200 sorts the multimedia file into a particular collection as defined by the rule. For example, given a rule specifying a collection of files uploaded within the past week, processor 200 compares a date attribute of each multimedia file with the rule value, i.e., between the current date and one week prior. If the date attribute falls within the rule value, multimedia file 212 is placed in the collection corresponding to files uploaded within the past week. In at least some embodiments, multimedia files may be sorted based on the originating device, e.g., multimedia files uploaded from a particular device such as photo files from a particular camera, or based on a user-defined event such as a vacation trip, business trip, wedding, etc. In at least some embodiments, different data structures may be used for storing the collections of multimedia files. In at least some embodiments, generate collection functionality 404 occurs automatically, i.e., without receiving explicit user input.

After completion of generate collection functionality 404, the process flow proceeds to publish functionality 406 wherein processor 200 publishes the collection of multimedia files 212 for access. In at least some embodiments, processor 200 generates a web-based photo album comprising the generated collection of multimedia files 212 from functionality 404. In at least some embodiments, processor 200 automatically generates the web-based photo album. In at least some embodiments, publishing to universal plug and play (UPnP) devices may be performed, e.g., to an Xbox system available from Microsoft Corp of Redmond, Washington, PlayStation 3 system available from Sony Corp. In at least some embodiments, publishing of the collection of multimedia files may be performed in an RSS-based format, e.g., using extensible markup language (XML), RSS is used to refer to one or more of really simple syndication, RDF site summary, or rich site summary.

FIG. 5 depicts a high-level functional process flow diagram of at least a portion 500 of generate collection functionality 404 according to an embodiment. Portion 500 comprises a set of instructions for execution by processor 200 to cause the processor to perform the functionality specified by FIG. 5.

Process flow portion 500 begins at apply rule functionality 502 wherein execution of a set of instructions by processor 200 causes the processor to apply a rule from rule set 218 to one of the multimedia files 212. If the evaluation of the rule with respect to the attribute 220 of the multimedia file 212 results in a positive (“YES”) determination, i.e., the rule is satisfied, the process flow proceeds to place file in collection functionality 504. If the evaluation of the rule with respect to the attribute 220 of the multimedia file 212 results in a negative (“NO”) determination, i.e., the rule is not satisfied, the process flow proceeds to more file determination functionality 506.

Execution of place file in collection functionality 504 by processor 200 causes the processor to place the file in a collection corresponding to the applied rule. In at least some embodiments, processor 200 stores a copy of the file in a particular directory structure whereas in other embodiments processor 200 may store a link to the file or use another mechanism to generate the collection. The process flow proceeds to more file determination functionality 506.

Execution of more file determination functionality 506 by processor 200 causes the processor to determine whether additional multimedia files 212 are present in storage device 210 to be evaluated with respect to the current rule. if the determination result is positive (“YES”), another multimedia file is selected and the flow of control returns to apply rule functionality 502. If the determination result is negative (“NO”), the flow of control proceeds to more rule determination functionality 508.

Execution of more rule determination functionality 508 by processor 200 causes the processor to determine whether additional rules are to be applied based on rule set 218. If the determination result is positive (“YES”), another rule is selected and the flow of control returns to apply rule functionality 502. If the determination result is negative (“NO”), the flow of control proceeds to publish functionality 406.

In at least some embodiments, the order of more file determination functionality 506 and more rule determination functionality 508 may be swapped such that the rule determination occurs prior to the file determination.

The functions of a method described in connection with the embodiments disclosed herein may be embodied in hardware, software, or a combination thereof. Software comprising instructions for execution may reside in a computer-readable medium comprising volatile and/or non-volatile memory, e.g., a random access memory, a read only memory, a programmable memory, a hard disk, a compact disc, or another form of storage medium readable, directly or indirectly, by a processing device.

What is claimed is:

1. A system for selectively publishing multimedia files 212, comprising:
a processing device 200;
a network interface 206 connected with the processing device 200; and
a storage device 210 connected with the processing device 200, the storage device 210 comprising:
a set of multimedia files 212 each having at least one attribute 220;
a set of predetermined rules 218; and
a set of executable instructions 214 which, when executed by the processing device 200, cause the processing device 200 to receive one or more multimedia files 212 each having at least one attribute 220; automatically generate a collection of multimedia files 212 by applying the set of predetermined rules 218 to at least one attribute 220 of each of the received one or more multimedia files 212; and publish the generated collection of multimedia files 212 for access.

2. The system as claimed in claim 1, wherein the instructions to cause the processing device 200 to receive one or more multimedia files 212 comprise instructions to cause the processing device 200 to detect a transfer of a multimedia file 212 to a specified location.

3. The system as claimed in claim 1, wherein the at least one attribute 220 is selected from a set comprising at least one attribute-based rule 218 selected from a set comprising an upload time, a file name, a file description, an originating computer, an originating device, or a file size.

4. The system as claimed in claim 1, wherein the instructions to cause the processing device 200 to generate a collection of multimedia files 212 comprises instructions causing the processing device 200 to add a multimedia file 212 to the collection for each multimedia file 212 having an attribute 220 which matches the set of predetermined rules 218.

5. The system as claimed in claim 1, wherein the set of predetermined rules 218 comprises at least one attribute-based rule 218 selected from a set comprising an upload time, a file name, a file description, an originating computer, an originating device, or a file size.

6. The system as claimed in claim 1, wherein the instructions to cause the processing device 200 to publish comprises generating a web-based album comprising the generated collection of multimedia files 212 for access by one or more web clients.

7. The system as claimed in claim 1, wherein the instructions further comprise instructions causing the processing device 200 to automatically update a prior generated collection of multimedia files 212 by applying the set of predetermined rules 218 to at least one attribute 220 of each of a set of newly received multimedia files 212.

8. The system as claimed in claim 1, wherein at least one rule of the set of predetermined rules 218 comprises whether a particular user has previously viewed the multimedia file 212.

9. A method of selectively publishing multimedia files 212, comprising:
receiving one or more multimedia files 212 each having at least one attribute 220;
automatically generating a collection of multimedia files 212 by applying a set of predetermined rules 218 to at least one attribute 220 of each of the received one or more multimedia files 212; and
publishing the generated collection of multimedia files 212 for access.

10. The method as claimed in claim 9, wherein said generating comprises adding a multimedia file 212 to the collection for each multimedia file having an attribute 220 which matches the set of predetermined rules 218.
